(19) United States
(12) Patent Application Publication
(10) Pub. No.: US 2024/0391342 A1
(43) Pub. Date: Nov. 28, 2024

(54) VEHICLE

(71) Applicant: TOYOTA JIDOSHA KABUSHIKI KAISHA, Toyota-shi (JP)

(72) Inventor: Masato HORIKOSHI, Okazaki-shi (JP)

(73) Assignee: TOYOTA JIDOSHA KABUSHIKI KAISHA, Toyota-shi (JP)

(21) Appl. No.: 18/661,950

(22) Filed: May 13, 2024

(30) Foreign Application Priority Data
May 24, 2023 (JP) 2023-085476

(51) Int. Cl. B60L 53/62; B60L 58/27; H01M 10/615; H01M 10/625; H01M 10/63; H01M 10/637

(52) U.S. Cl. CPC B60L 53/62; B60L 58/27; H01M 10/615; H01M 10/625; H01M 10/63; H01M 10/637; B60L 2240/545; H01M 2220/20

(57) ABSTRACT

A vehicle is configured to perform external charging for charging a battery using feed power that is supplied from a power facility provided outside the vehicle. The vehicle includes a heating device and an ECU. The heating device is configured to heat the battery. The ECU performs temperature adjustment control for adjusting a temperature of the battery by controlling the heating device in each of a first period and a second period, the first period being a period during which the external charging is performed, the second period being a period after the external charging is stopped. The temperature of the battery adjusted by the temperature adjustment control during the second period is lower than the temperature of the battery adjusted by the temperature adjustment control during the first period.

### CROSS REFERENCE TO RELATED APPLICATIONS

This nonprovisional application is based on Japanese Patent Application No. 2023-085476 filed on May 24, 2023 with the Japan Patent Office, the entire contents of which are hereby incorporated by reference.

### BACKGROUND

### Field

The present disclosure relates to a vehicle.

### Description of the Background Art

Japanese Patent Laying-Open No. 2016-177931 discloses a vehicle equipped with a power supply system including a power storage device, a converter, and a controller. The vehicle is configured to be capable of executing external charging for charging the power storage device by a power supply external to the vehicle. The controller performs temperature rise (heating) control of the power storage device using heat generated in the reactor during external charging.

### SUMMARY

In Japanese Patent Laying-Open No. 2016-177931, a technique for adjusting the temperature of the power storage device during external charging is discussed. On the other hand, in an environment such as a very low-temperature environment, the temperature of the power storage device may be adjusted to maintain the temperature after the external charging, for example. In Japanese Patent Laying-Open No. 2016-177931, it is not discussed as to how the temperature of the power storage device is optimally adjust over a total period consisting of a temperature adjustment period during the external charging and a temperature adjustment period after the external charging.

The present disclosure has been made to solve the above-described problem, and has an object to optimize temperature adjustment of a power storage device when the temperature of the power storage device is adjusted during and after external charging.

A vehicle according to the present disclosure is configured to perform external charging for charging a power storage device in the vehicle using feed power that is supplied from a power facility provided outside the vehicle. The vehicle includes a heating device and a controller. The heating device is configured to heat the power storage device. The controller performs temperature adjustment control for adjusting a temperature of the power storage device by controlling the heating device in each of a first period and a second period, the first period being a period during which the external charging is performed, the second period being a period after the external charging is stopped. The temperature of the power storage device adjusted by the temperature adjustment control during the second period is lower than the temperature of the power storage device adjusted by the temperature adjustment control during the first period.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a diagram illustrating an overall configuration of a vehicle according to the present embodiment.

FIG. 2 is a diagram specifically illustrating temperature control performed by an ECU (Electronic Control Unit) in connection with external charging in the embodiment.

FIG. 3 is a flowchart illustrating processing and control executed by an ECU;

FIG. 4 is a diagram for explaining the relationship between the magnitude of the feed power and the upper limit and the lower limit of the target temperature range.

FIG. 5 is a diagram for explaining the relationship between the temperature TB and Win.

FIG. 6 is a diagram specifically illustrating temperature control performed by an ECU in connection with external charging in a second modification.

### DESCRIPTION OF THE PREFERRED EMBODIMENTS

Hereinafter, embodiments of the present disclosure will be described in detail with reference to the drawings. In the drawings, the same or corresponding parts are denoted by the same reference numerals, and the description thereof will not be repeated.

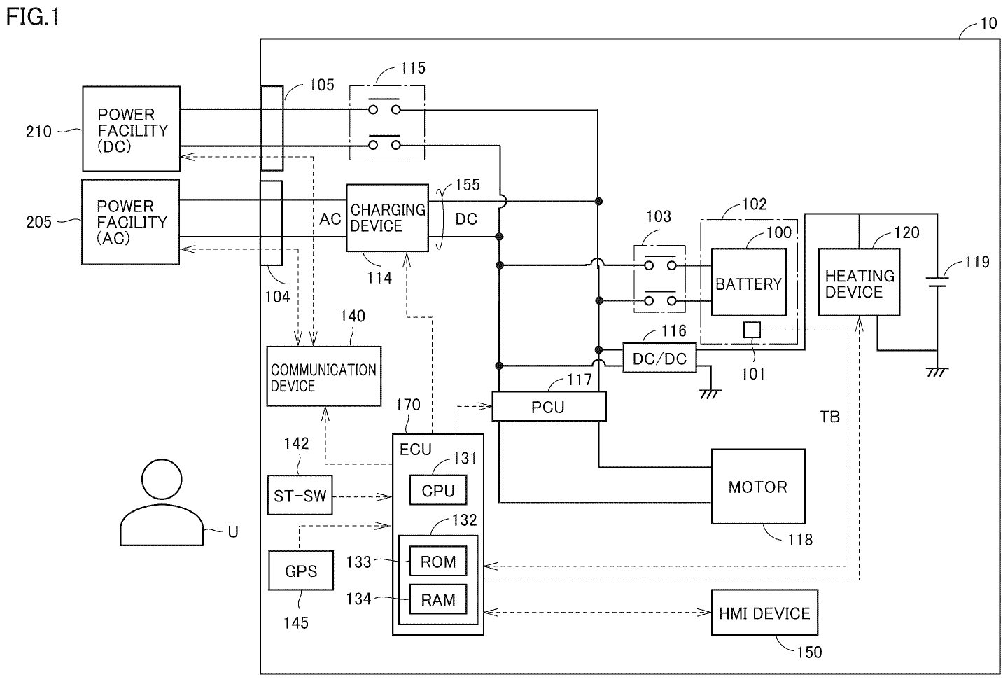

FIG. 1 is a diagram illustrating an overall configuration of a vehicle 1 according to the present embodiment. Referring to FIG. 1, a vehicle 1 is an electrically powered vehicle capable of executing external charging, and is, for example, a battery electric vehicle (BEV). The external charging refers to charging the battery 100 (described later) using power supplied from a power facility provided outside the vehicle 1.

The vehicle 1 includes a battery pack 102, an SMR (System Main Relay) 103, inlets 104 and 105, a charging device 114, and a charging relay 115. The vehicle 1 further includes a DC/DC converter 116, a PCU (Power Control Unit) 117, a motor 118, an auxiliary battery 119, and a heating device 120. The vehicle 1 further includes a communication device 140, a start switch 142, GPS (Global Positioning System) 145, an HMI (Human Machine Interface) device 150, and an ECU (controller) 170.

The battery pack 102 includes a battery 100 and a temperature sensor 101. The battery 100 is an example of a power storage device mounted on the vehicle 1, and is a secondary battery such as a lithium ion battery. During external charging, the battery 100 self-heats due to its input power (charging power). The upper limits of the input power and the output power of the battery 100 are also denoted as Win and Wout, respectively. In a temperature range from an extremely low temperature to a normal temperature, Win and Wout are larger as the temperature TB is higher.

The temperature sensor 101 detects the temperature TB (battery temperature) of the battery 100. The battery pack 102 further includes a current sensor and a voltage sensor (both not shown). The current sensor and the voltage sensor detect the current and the voltage of the battery 100, respectively. The SMR 103 is electrically connected to the battery 100.

The inlets 104 and 105 receive power supplied from the power facilities 205 and 210, respectively. Each of the power facilities 205 and 210 is provided outside the vehicle 1. The power to be supplied to the power facility 205 and the power to be supplied to the power facility 210 are AC (Alternating Current) power and DC (Direct Current) power, respectively. External charging using AC power from the power facility 205 is also referred to as AC charging. External charging using DC power from the power facility 210 is also referred to as “DC charging”.

The charging device 114 is connected between the SMR 103 and the inlet 104, and includes an insulated AC/DC converter. The charging device 114 converts the power received by the inlet 104 (AC power) into charging power for the battery 100 (DC power). The charging relay 115 is connected between the SMR 103 and the inlet 105.

The DC/DC converter 116 steps down power output from the battery 100 through the SMR 103 or power supplied from the charging device 114 (or the power facility 210) during external charging. The stepped-down power is supplied to the auxiliary battery 119 or the heating device 120.

The PCU 117 converts DC power output from the battery 100 through the SMR 103 into AC power during activation of the traveling system of the vehicle 1. The motor 118 receives AC power from the PCU 117 and generates driving force for driving the vehicle 1.

The auxiliary battery 119 is a secondary battery that stores auxiliary power. The heating device 120 operates using electric power supplied from the DC/DC converter 116 or electric power of the auxiliary battery 119. The heating device 120 is configured to heat the battery 100. Specifically, the heating device 120 indirectly heats the battery 100 via a heat medium (refrigerant) flowing inside or below the battery pack 102. The heating device 120 may be a heater or the like that directly heats the battery 100.

The communication device 140 is configured to exchange various kinds of information by communicating with the power facility 205 (or the power facility 210). The information includes information indicating the magnitude of the feed power, an external charging start command, and an external charging stop command. Communication between the communication device 140 and the power facility 205 (or the power facility 210) is, for example, CAN (Controller Area Network) communication. The communication device 140 is capable of wirelessly communicating with a server (not shown) outside the vehicle 1. The server stores a map database.

The start switch 142 receives a user operation for instructing activation/stop of the traveling system of the vehicle 1 (ON/OFF of the SMR 103). The GPS 145 measures the current position of the vehicle 1.

The HMI device 150 receives various user operations from the user U. The user operation includes an operation of setting a scheduled traveling-start time of the vehicle 1, an operation of setting an end time of timer charging, and an operation of setting a target SOC (State Of Charge) of the battery 100 at the time of external charging. The scheduled traveling-start time is a scheduled time at which the vehicle 1 is scheduled to start traveling. In the embodiment, the user U operates the start switch 142 at this time to start driving the vehicle 1. The timer charging is external charging executed according to a predetermined schedule. In this example, it is assumed that the timer charging is performed so that the SOC of the battery 100 reaches the target SOC at the end time. The target SOC is, for example, 100%. The user operation further includes an operation of setting a destination of the vehicle 1. The HMI device 150 can display the travel route from the current position of the vehicle 1 to the destination. The information indicating the travel route is acquired from an external server by the communication device 140.

The ECU 170 includes CPU (Central Processing Unit) 131 and a memory 132. The CPU 131 executes various arithmetic processing. The memory 132 includes a read only memory (ROM) 133 and a random access memory (RAM) 134. The ROM 133 stores programs executed by the CPU 131 and various data.

The ECU 170 sets Win and Wout, calculates the SOC of the battery 100, and controls various devices of the vehicle 1 according to the detection values of the temperature sensor 101, the voltage sensor, and the current sensor. The device includes an SMR 103, a charging device 114, a charging relay 115, a DC/DC converter 116, a PCU 117, a heating device 120, a communication device 140, and an HMI device 150.

The ECU 170 executes temperature adjustment control for adjusting the temperature TB by controlling the heating device 120. For example, during external charging, the ECU 170 intermittently drives the heating device 120 so that the temperature TB falls within the target temperature range. Since the higher the target temperature range is, the higher the frequency of driving the heating device 120 is, the longer the driving time of the heating device 120 is. On the other hand, since the lower the target temperature range is, the lower the frequency of driving the heating device 120 is, the shorter the driving time of the heating device 120 is.

The ECU 170 controls external charging by controlling the charging device 114 or the charging relay 115 and the communication device 140. The external charging is started when the start of power feed is instructed by the user U in a state where the vehicle 1 is connected to the power facility 205 (or the power facility 210). The external charging is stopped when the SOC of the battery 100 reaches the target SOC. In this case, the ECU 170 transmits a command to stop external charging to the power facility 205 (or the power facility 210) through the communication device 140, and stops the charging device 114 (or opens the charging relay 115).

In a period (first period) in which external charging is performed, it is preferable to appropriately warm the battery 100 in order to improve charging efficiency of the battery 100. In particular, at the time of AC charging, since the feed power is smaller than that at the time of DC charging and the self-heating amount of the battery 100 is smaller, it is important to appropriately warm the battery 100. Further, in a period (second period) after the external charging is stopped, it is preferable that the battery 100 be appropriately warmed so that the battery 100 can output a sufficient amount of electric power when the vehicle 1 starts traveling. In particular, in an extremely low temperature environment, the battery 100 is excessively cooled and Win and Wout are likely to become small, and it is important to keep the battery 100 in a moderate temperature.

As described above, as the temperature TB is higher, the Win and the Wout are basically higher. Therefore, the temperature TB (first adjustment temperature) adjusted by the temperature adjustment control during the first period is preferably appropriately high from the viewpoint of shortening the charging time of the battery 100. On the other hand, the temperature TB (second adjustment temperature) adjusted by the temperature adjustment control during the second period is typically the temperature keeping temperature of the battery 100. The heat retention temperature is determined in advance by, for example, experiments based on the capacity of the battery pack 102. While the battery 100 is kept warm, the output power of the battery 100 may be large to some extent, and does not need to be as large as that at the time of external charging. Rather, unnecessarily increasing the temperature of the battery 100 leads to an increase in the power consumption of the heating device 120. Therefore, it may be preferable that the temperature TB during the second period be moderately low. Thus, the preferred temperature of the battery 100 varies depending on the circumstances.

In the embodiment, the ECU 170 executes the temperature control of the battery 100 in each of the first period in which the external charging is executed and the second period after the external charging is stopped. The temperature adjustment control includes controlling the heating device 120 such that the second adjustment temperature (the heat retention temperature) is lower than the first adjustment temperature.

With such a configuration, the temperature TB during the first period is adjusted to be relatively high, and the temperature TB during the second period is adjusted to be relatively low. Since the temperature TB during the first period is high, Win can be increased. As a result, the charging efficiency is improved, and the charging time of the battery 100 can be shortened. Further, since the temperature TB during the second period is low, the driving time of the heating device 120 during the second period can be reduced. As a result, power consumption of the heating device 120 (vehicle 1) can be reduced.

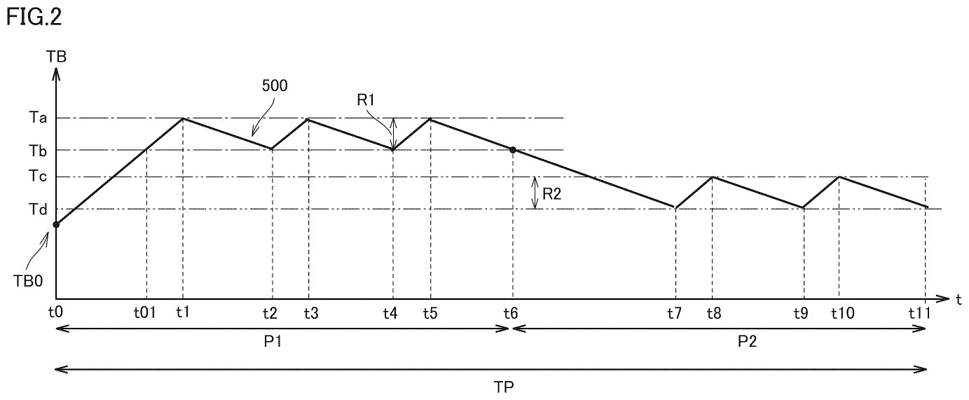

FIG. 2 is a diagram specifically illustrating temperature control performed by ECU 170 in connection with external charging in the embodiment. In this example, the external charging is timer charging.

Referring to FIG. 2, line 500 represents the transition of temperature TB (battery temperature). The periods P1 and P2 correspond to the first period and the second period, respectively. The ranges R1 and R2 are target temperature ranges of the battery 100 during the periods P1 and P2, respectively. The upper limit Ta and the lower limit Tb are the upper limit and the lower limit of the range R1, respectively. The upper limit Tc and the lower limit Td are the upper limit and the lower limit of the range R2, respectively. Each of the upper limits Ta and Tc and the lower limits Tb and Td is predetermined. The upper limit Tc is lower than the upper limit Ta. The lower limit Td is lower than the lower limit Tb. A period including the periods P1 and P2 is also referred to as a total period TP. The upper limit Ta and the lower limit Tb may be set based on the magnitude of the feed power. This point will be described later in Modification 1.

At time t0, timer charging starts and the ECU 170 thereby starts driving the heating device 120. As a result, the temperature TB starts to rise from TB0, and exceeds the lower limit Tb at time t01. The heating device 120 may be driven before time t0 (pre-heating).

At time t1, the ECU 170 stops the heating device 120 so that the temperature TB does not exceed the upper limit Ta. Between time t1 and time t2, the temperature TB starts to decrease due to heat dissipation from the battery 100. At time t2, the ECU 170 drives the heating device 120 so that the temperature TB does not fall below the lower limit Tb. As a result, the temperature TB starts to rise again.

Similarly, during the period from time t2 to time t6, the ECU 170 repeats driving and stopping of the heating device 120. As described above, the temperature control during the period P1 includes the control of adjusting the temperature TB within the range R1 by intermittently driving the heating device 120.

At time t6, the SOC reaches the target SOC and the timer charging ends. Since the range R2 in the period P2 after the time t6 is lower than the range R1, the ECU 170 does not drive the heating device 120 at the time t6. As a result, the temperature TB continues to decrease after time t6.

At time t7, the heating device 120 is driven so that the temperature TB does not fall below the lower limit Td. From time t7 to time t11, the ECU 170 adjusts the temperature TB in the same manner as during the period P1. As described above, the temperature control during the period P2 includes the control of adjusting the temperature TB within the range R2 by intermittently driving the heating device 120.

At time t11, the scheduled traveling-start time of the vehicle 1 arrives, the travel system is activated due to the operation of the start switch 142, and the temperature control by the ECU 170 ends. Information indicating the scheduled traveling-start time (time t11) is stored in the memory 132. The time t11 is included in the period P2.

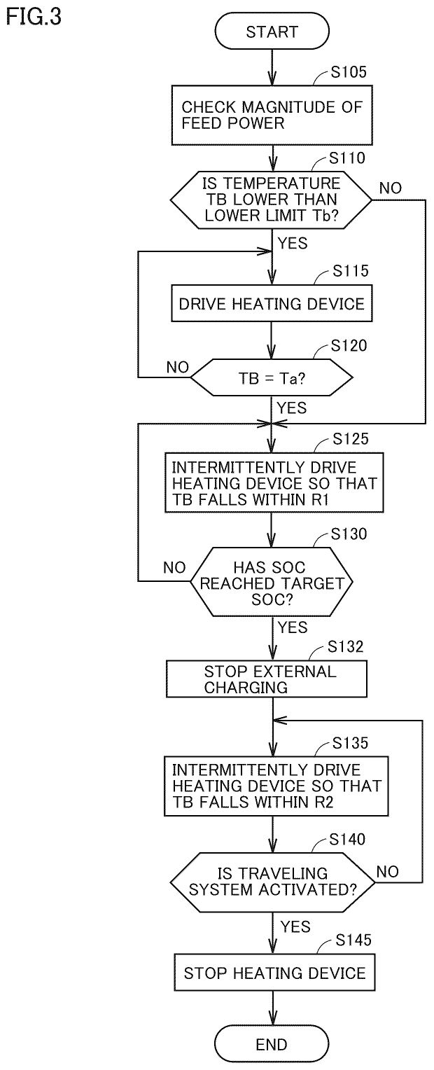

FIG. 3 is a flowchart illustrating processing and control executed by the ECU 170. This flowchart starts when the vehicle 1 is connected to a power facility and external charging (AC charging in this example) is started. Hereinafter, the step is abbreviated as “S”.

Referring to FIG. 3, ECU 170 acquires information indicating the magnitude of the feed power of power facility 205 from power facility 205 by CAN communication, and checks the magnitude of the feed power (S105). Thereafter, the ECU 170 determines whether or not the temperature TB (battery temperature) is lower than the lower limit Tb (range R1) (S110). When the temperature TB is equal to or higher than the lower limit Tb (NO in S110), the process proceeds to S125. When temperature TB is lower than range R1 (YES in S110), ECU 170 drives heating device 120 (S115).

The ECU 170 determines whether or not the temperature TB has increased to the upper limit Ta (S120). When the temperature TB has not increased to the upper limit Ta (NO in S120), the process returns to S115. When temperature TB rises to upper limit Ta (YES in S120), ECU 170 stops heating device 120, and then intermittently drives heating device 120 so that temperature TB falls within range R1 (S125). S115 and S125 correspond to the temperature control during the period P1.

The ECU 170 determines whether or not the SOC has reached the target SOC (S130). When the SOC has not yet reached the target SOC (NO in S130), the process returns to S125. When the SOC reaches the target SOC (YES in S130), ECU 170 stops the external charging (S132).

Thereafter, the ECU 170 intermittently drives the heating device 120 so that the temperature TB falls within the range R2 in order to keep the battery 100 warm (S135). Specifically, the ECU 170 stops the heating device 120 when the temperature TB rises to the upper limit Tc, and thereafter repeats the control of driving the heating device 120 when the temperature TB falls to the upper limit Td. S135 corresponds to the temperature control during the period P2.

The ECU 170 determines whether or not the traveling system is activated (S140). Specifically, the ECU 170 determines whether or not the start switch 142 is operated. When the traveling system is activated (YES in S140), ECU 170 stops heating device 120 (S145). That is, the ECU 170 ends the series of control of the heating device 120. Otherwise (NO in S140), the process returns to S135.

As described above, according to the embodiment, the heating device 120 is controlled so that the second adjustment temperature (range R2) is lower than the first adjustment temperature (range R1). Accordingly, power consumption in the vehicle 1 can be reduced while reducing the charging time. Therefore, the adjustment of the temperature TB can be optimized in terms of efficiency over the total period TP.

### Modification 1 of Embodiment

In the case where the input power of the battery 100 is small because of the small amount of supply of power, it is not necessary to increase the temperature TB so much in order to increase the Win. Rather, unnecessarily increasing the temperature TB leads to an increase in the power consumption of the heating device 120.

Referring to FIG. 2 again, in order to deal with such a problem, the ECU 170 according to the first modification sets the upper limit Ta and the lower limit Tb to be lower when the power to be supplied is small than when the power to be supplied is large. In this case, the temperature control by the ECU 170 corresponds to controlling the heating device 120 such that the range R1 in the case where the feed power is small is lower than the range R1 in the case where the feed power is large. As a result, in the period P1, the temperature TB when the feed power is small becomes lower than the temperature TB when the feed power is large.

According to the temperature control described above, when the power supplied during the period P1 is relatively small, the driving time of the heating device 120 during the period P1 can be reduced.

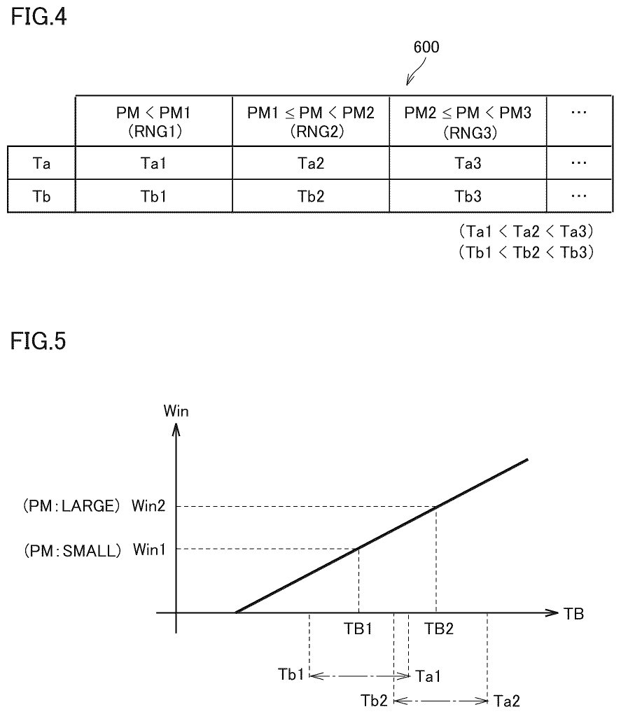

FIG. 4 is a diagram for explaining the relationship between the magnitude (PM) of the feed power and the upper limit Ta and the lower limit Tb. Referring to FIG. 4, data 600 is stored in memory 132. The ECU 170 acquires information indicating the magnitude of the feed power from the power facility 205 (or the power facility 210) via the communication device 140. The ECU 170 sets the upper limit Ta and the lower limit Tb (range R1) according to the information and the data 600. For example, when PM is within the range RNG1, the upper limit Ta and the lower limit Tb are set to Ta1 and Tb1, respectively. When PM is within the range RNG2, the upper limit Ta and the lower limit Tb are set to Ta2 and Tb2, respectively (Ta1<Ta2 and Tb1<Tb2).

FIG. 5 is a diagram illustrating a relationship between a temperature TB and Win. In this example, the power to be supplied is AC power from the power facility 205. The input power is DC power supplied from the charging device 114 to the battery 100 during AC charging, and is determined according to the feed power (AC power).

Referring to FIG. 5, when PM is relatively small (e.g., within the range RNG1 of FIG. 4), it is not necessary to increase the temperature TB so much in order to increase Win. In this example, it is sufficient to set Win to Win1, and therefore, the temperature TB is adjusted to near TB1. On the other hand, when PM is relatively large (e.g., within the range RNG2 in FIG. 4), it is necessary to increase the temperature TB in order to increase Win. In this case, the temperature TB is adjusted to the vicinity of TB2 (>TB1) so that Win is set to Win2 (>Win1). In this example, Tb1<TB1<Ta1 and Tb2<TB2<Ta2.

According to the first modification, when the power to be supplied during the period P1 is relatively small, the driving time of the heating device 120 during the period P1 can be reduced, so that power consumption in the vehicle 1 can be reduced.

### Modification 2 of Embodiment

As described above, the second adjustment temperature is preferably basically lower than the first adjustment temperature. On the other hand, it may be preferable that the second adjustment temperature be higher as being higher than the first adjustment temperature. For example, it is assumed that the scheduled traveling-start time of the vehicle 1 is set and the required driving force of the vehicle 1 after this time is large. In this case, from the viewpoint of improving the traveling performance of the vehicle 1, it is preferable that the second adjustment temperature before the start of traveling be high so that Wout after the scheduled traveling-start time becomes large.

In the first modification, when it is predicted that the required driving force of the vehicle 1 after the scheduled traveling-start time is larger than the threshold, the ECU 170 controls the heating device 120 so that the pre-traveling-start adjustment temperature of the battery 100 becomes higher than the first adjustment temperature.

The pre-traveling-start adjustment temperature refers to a temperature TB adjusted by temperature adjustment between the pre-traveling-start time of the vehicle 1 and the scheduled traveling-start time. The pre-traveling-start time is defined as a time that is a predetermined time (for example, 10 minutes) before the scheduled traveling-start time. The ECU 170 predicts that the required driving force is greater than the threshold based on, for example, that the gradient of the uphill slope of the travel route from the current position of the vehicle 1 to the destination is higher than a predetermined value. The information representing the predetermined time, the threshold, and the predetermined value are stored in the memory 132.

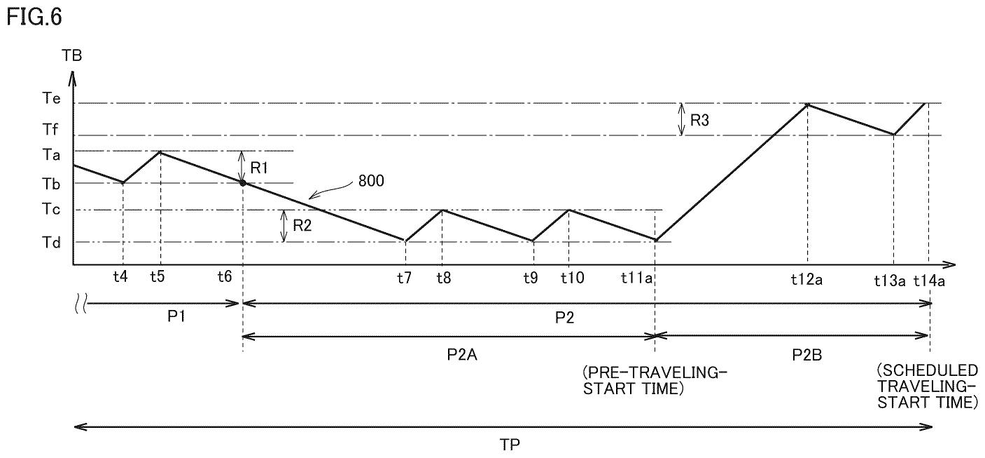

FIG. 6 is a diagram specifically illustrating temperature control performed by the ECU 170 in connection with external charging in the second modification. This figure differs from FIG. 2 in that time t11 is replaced by time t11a and time t11a to time t14a are added.

Referring to FIG. 6, a line 800 represents a transition of the temperature TB. The time t11a is included in the period P2 and is the pre-traveling-start time. The time t14a is included in the period P2 and is the scheduled traveling-start time. The period from time t6 to time t11a is also referred to as a period P2A. The period from time t11a to time t14a is also referred to as a period P2B. The periods P2A and P2B are included in the period P2.

The upper limit Tc is an upper limit of a target temperature range (range R2) of the battery 100 during the period P2A. The lower limit Td is a lower limit of the target temperature range (range R2) of the battery 100 during the period P2A. The upper limit Te is an upper limit of the target temperature range (range R3) of the battery 100 during the period P2B. The lower limit Tf is the lower limit of the target temperature range (range R3) of the battery 100 during the period P2B. The upper limit Te is higher than the upper limit Ta. The lower limit Tf is higher than the lower limit Tb. The temperature TB within the range R3 corresponds to the pre-traveling-start adjustment temperature.

By controlling the heating device 120 based on the required driving force of the vehicle 1 after the scheduled traveling-start time, the temperature TB immediately before the travel start can be increased as the temperature becomes higher than the first adjusted temperature (R1<R3). Thus, Wout can be increased immediately after the scheduled traveling-start time (time t14a). As a result, the user U can immediately drive the vehicle 1 in a state in which the running performance of the vehicle 1 is improved. Further, during the period P2A, power consumption of the heating device 120 can be reduced.

### Modification 3 of Embodiment

When DC charging of the vehicle 1 is performed, that is, when the feed power is DC power, the ECU 170 may stop the heating device 120 based on the temperature TB rising to a temperature within the range R1 (for example, an average temperature of Ta and Tb) during the period P1.

The input power when DC charging is performed is typically greater than the input power when AC charging is performed. Thus, the self-heating amount of the battery 100 during DC charging is typically greater than the self-heating amount during AC charging. Even when the ECU 170 stops the heating device 120 as described above, the temperature TB can be maintained within the range R1 due to the self-heating of the battery 100. Accordingly, unlike during AC charging, it is not necessary to operate the heating device 120 after the temperature TB rises within the range R1 during the period P1, and thus it is possible to reduce power consumption in the vehicle 1.

### Other Modifications

The external charging may be temporarily stopped (interrupted) before the SOC reaches the target SOC. For example, when the user U performs an operation of temporarily stopping the external charging, the ECU 170 may keep the battery 100 warm during a period from the temporary stop to the restart of the external charging. In this case, the temperature control by the ECU 170 also includes controlling the heating device 120 so that the temperature TB during this period is lower than the temperature TB (first adjusted temperature) before the temporary stop of the external charging.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A vehicle configured to perform external charging for charging a power storage device in the vehicle using feed power that is supplied from a power facility provided outside the vehicle, the vehicle comprising:
a heating device that heats the power storage device; and
a controller that performs temperature adjustment control for adjusting a temperature of the power storage device by controlling the heating device in each of a first period and a second period, the first period being a period during which the external charging is performed, the second period being a period after the external charging is stopped, wherein
the temperature of the power storage device adjusted by the temperature adjustment control during the second period is lower than the temperature of the power storage device adjusted by the temperature adjustment control during the first period.

2. The vehicle according to claim 1, wherein
the temperature adjustment control includes
control for adjusting the temperature of the power storage device to fall within a first range by intermittently driving the heating device during the first period, and
control for adjusting the temperature of the power storage device to fall within a second range by intermittently driving the heating device during the second period,
an upper limit of the second range is lower than an upper limit of the first range, and
a lower limit of the second range is lower than a lower limit of the first range.

3. The vehicle according to claim 1, wherein during the first period, the temperature of the power storage device when the feed power is small is lower than the temperature of the power storage device when the feed power is large.

4. The vehicle according to claim 2, wherein when the feed power is direct current power, the controller stops the heating device based on the temperature of the power storage device being increased to fall within the first range during the first period.

5. The vehicle according to claim 1 further comprising a storage device that stores a first time, the first time being a scheduled time at which the vehicle is scheduled to start traveling, wherein
the second period includes the first time and a second time, the second time being a time preceding the first time by a predetermined time, and
when it is predicted that required driving force of the vehicle after the first time is larger than a threshold, the temperature of the power storage device adjusted by the temperature adjustment control during a period from the second time to the first time is higher than the temperature of the power storage device adjusted by the temperature adjustment control during the first period.
